(19) United States
(12) Patent Application Publication
(10) Pub. No.: US 2013/0089703 A1
(43) Pub. Date: Apr. 11, 2013

(54) SOLDER RESIST COMPOSITION, BOARD FOR PACKAGE COMPRISING SOLDER RESIST OPENING USING THE COMPOSITION, AND METHOD FOR PREPARING THE BOARD FOR PACKAGE

(71) Applicants: SAMSUNG ELECTRO-MECHANICS CO., LTD., Suwon (KR); SUNGKYUNKWAN UNIVERSITY FOUNDATION FOR CORPORATE COLLABORATION, Suwon (KR)

(72) Inventors: Dae Jo HONG, Hwaseong (KR); Chang Bo Lee, Suwon (KR); Cheol Ho Choi, Hwaseong (KR); Tae Ho Kim, Suwon (KR); Archana S. Patole, Suwon (KR); Jeong Min Hyeon, Suwon (KR); Da Hye Kim, Suwon (KR)

(73) Assignees: SUNGKYUNKWAN UNIVERSITY FOUNDATION FOR CORPORATE COLLABORATION, Suwon (KR); SAMSUNG ELECTRO-MECHANICS CO., LTD., Suwon-si (KR)

(21) Appl. No.: 13/649,617

(22) Filed: Oct. 11, 2012

(30) Foreign Application Priority Data
Oct. 11, 2011 (KR) 10-2011-0103623

(51) Int. Cl. C09D 163/00; B05D 3/06; B32B 3/24

(52) U.S. Cl. 428/138; 523/400; 427/555

(57) ABSTRACT

The present invention relates to a solder resist composition including: 1 to 10 parts by weight of a triazene curing agent; 1 to 10 parts by weight of a curing accelerator; and 10 to 50 parts by weight of a diluent, with respect to 100 parts by weight of an epoxy base, a board for a package comprising a solder resist opening using the same, and a method for preparing the board for a package.

According to the present invention, it is possible to form a small solder resist opening of less than about 50 μm through laser ablation and improve laser processability of the thermosetting solder resist composition.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2011-0103623, entitled filed Oct. 11, 2011, which is hereby incorporated by reference in its entirety into this application.

### BACKGROUND OF THE INVENTION

1. Field of the Invention

The present invention relates to a solder resist composition, a board for a package comprising a solder resist opening using the composition, and a method for preparing the board for a package.

2. Description of the Related Art

According to high function of electronic products and combination of various functions, a printed circuit board, one of electronic components, also becomes thinner and multilayered. Accordingly, dimensions are required to become finer.

Recently, as patterns become finer, in case of a circuit, patterns of less than L/S=10/10 μm have been developed and are in the initial state of mass production, and in case of a board, a thickness of about 100 μm has been applied. Particularly, in case of a board for a package (PKG) used for connection between a main board and semiconductors, the board becomes thinner, circuit patterns become finer, and a pitch of bumps connecting with semiconductor chips becomes finer.

A bump pitch of boards for a PKG, which are currently being mass-produced, is about 150 μm, and products with a bump pitch of 130 μm are in the initial state of mass production. It is expected that a bump pitch of less than 100 μm will be applied within the next two or three years.

Meanwhile, as a bump pitch becomes narrower, a diameter of solder resist openings (SRO) of a board for a PKG, on which bumps are formed, also should be smaller. In order to form a small opening, conventional methods use a UV light source, a photo mask, and photosensitive resist (PSR) having both thermosetting and photocurable properties.

A schematic diagram of a typical process of forming an SRO for connection of a semiconductor chip in solder resist is shown in the following FIG. 1. First, PSR is applied on a pretreated printed circuit board and dried, an exposure process of performing photo curing (negative method) by selectively transmitting UV light to the PSR through a photo mask or photolysis (positive method) is performed, and the PSR in a portion, where an opening is to be formed, is removed in a developing process to finish the process.

However, this method has technical problems that the size of the opening is changed and the speed and end time of photoreaction of the PSR should be precisely controlled in order to reduce the size of the opening.

The following FIG. 2 is an enlarged view of a bump portion in which a board for a PKG and a semiconductor chip are connected, and it is possible to check that the size of openings B and b formed in solder resist is reduced as bump pitches A and a become narrower.

When using PSR, currently, it is possible to control an SRO diameter up to 60 μm, but it is necessary to adjust it to a finer size.

Recently, for a size of less than 50 μm, a method of forming an opening by pyrolyzing solder resist through laser ablation is being attempted. A process of forming a bump opening using laser ablation is shown in the following FIG. 3.

First, solder resist (SR) is applied on a pretreated printed circuit board and thermally cured, the SR in a portion, where an opening is to be formed, is removed through laser ablation, and a desmear process is performed to form an opening.

An SR composition, which forms an opening through laser ablation, has only thermosetting properties unlike an existing PSR composition. This thermosetting SR composition consists of a base, a curing agent, a curing accelerator, and a diluent, and dyes, inorganic materials, and so on are added thereto.

A thermosetting resin can achieve reduction in investment costs and increase in space utilization due to simplification of processes as well as excellent reliability of assembled products due to excellent thermal stability compared to a conventional PSR material.

The base is mainly an epoxy resin, and the curing agent is a phenol or imide material. The curing accelerator is an amine or imidazole material, and the diluent is an ester or ketone material.

However, the conventional thermosetting SR composition has difficulty in pyrolysis due to laser processing. Since it is difficult to be processed, laser power should be increased to form a small-diameter opening, and a copper (Cu) circuit layer, a substrate under SR may be damaged due to increase in power.

### SUMMARY OF THE INVENTION

The present invention has been invented in order to overcome the above-described problems and it is, therefore, an object of the present invention to provide a thermosetting solder resist composition capable of overcoming several problems of the prior art in being applied to laser ablation equipment or similar equipment with polymer resolution among methods of forming a solder resist opening of a board for a package.

Further, it is another object of the present invention to provide a board for a package (PKG) manufactured from the thermosetting solder resist composition and having a small diameter opening, improved processing performance, and no damage to a copper (Cu) circuit layer, that is, a substrate under solder resist.

Further, it is still another object of the present invention to provide a method for preparing the board for a PKG.

In accordance with an embodiment of the present invention to achieve the object, there is provided a solder resist composition including: 1 to 10 parts by weight of a triazene curing agent represented as the following chemical formula 1; 1 to 10 parts by weight of a curing accelerator; and 10 to 50 parts by weight of a diluent, with respect to 100 parts by weight of an epoxy base.

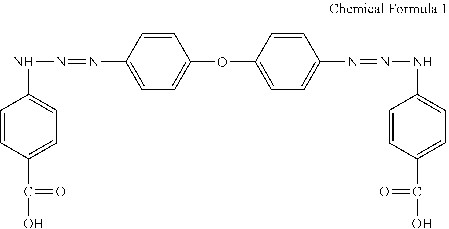 [SMILES: O=C(O)c1ccc(NN=Nc2ccc(Oc3ccc(N=NNc4ccc(C(=O)O)cc4)cc3)cc2)cc1]

The epoxy base may be at least one selected from compounds represented as the following chemical formulas 2 to 4.

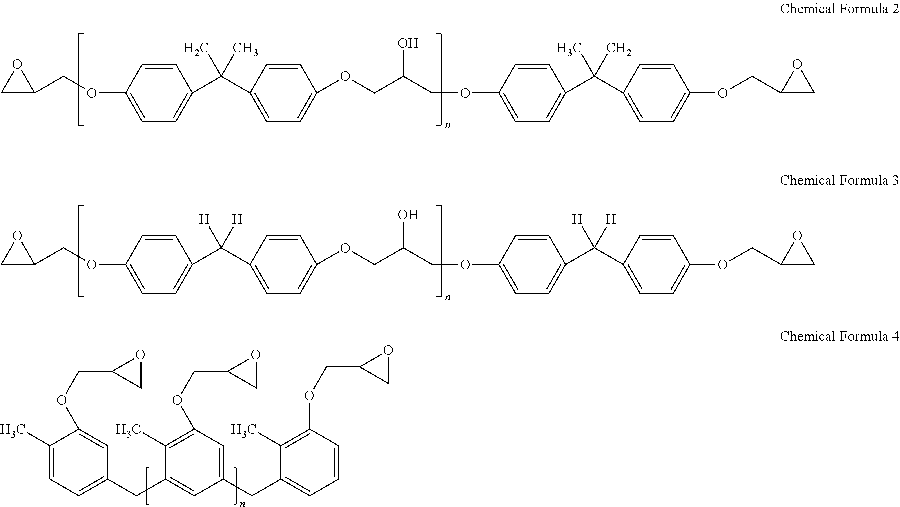

In the chemical formulas 2 to 4, n is 1 to 10.

The curing accelerator may be at least one selected from the group consisting of amine derivatives, imidazole derivatives, and phosphine derivatives.

For a concrete example, the curing accelerator may be triphenylphosphine, triethylamine, 1,3-phenylenediamine, 2-methylimidazole, and 2-ethyl-4-methylimidazole but not limited thereto.

The composition may be a thermosetting solder resist composition.

Further, the present invention may provide a board for a package including a solder resist opening using a solder resist composition.

It is preferred that the solder resist opening is less than 50 μm.

Further, the present invention may provide a method for preparing a board for a package including: applying a solder resist composition on a board; curing the solder resist composition; and forming an opening in the cured solder resist.

It is preferred that the solder resist composition includes 1 to 10 parts by weight of a triazene curing agent represented as the chemical formula 1; 1 to 10 parts by weight of a curing accelerator; and 10 to 50 parts by weight of a diluent, with respect to 100 parts by weight of an epoxy base.

The formation of the solder resist opening may use laser ablation.

The laser ablation may use CO₂ laser, Yag laser, and excimer laser equipment and equipment which enables pyrolysis of polymers.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic diagram of a process of forming an solder resist (SR) opening for connection of SR and a semiconductor chip;

FIG. 2 is an enlarged view of a bump portion in which a board for a PKG and a semiconductor chip are connected;

FIG. 3 is a schematic diagram of a process of forming an SR opening using a method of the present invention;

FIG. 4 shows evaluation results of resolution of SR openings in accordance with embodiments and comparative examples; and

FIG. 5 shows evaluation results of adhesion between EMC and SR openings in accordance with embodiments and comparative examples.

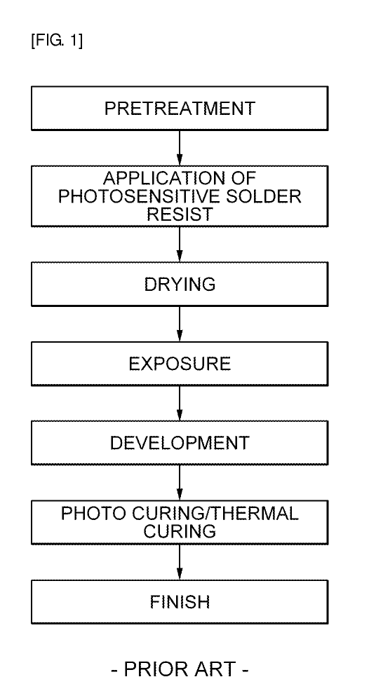

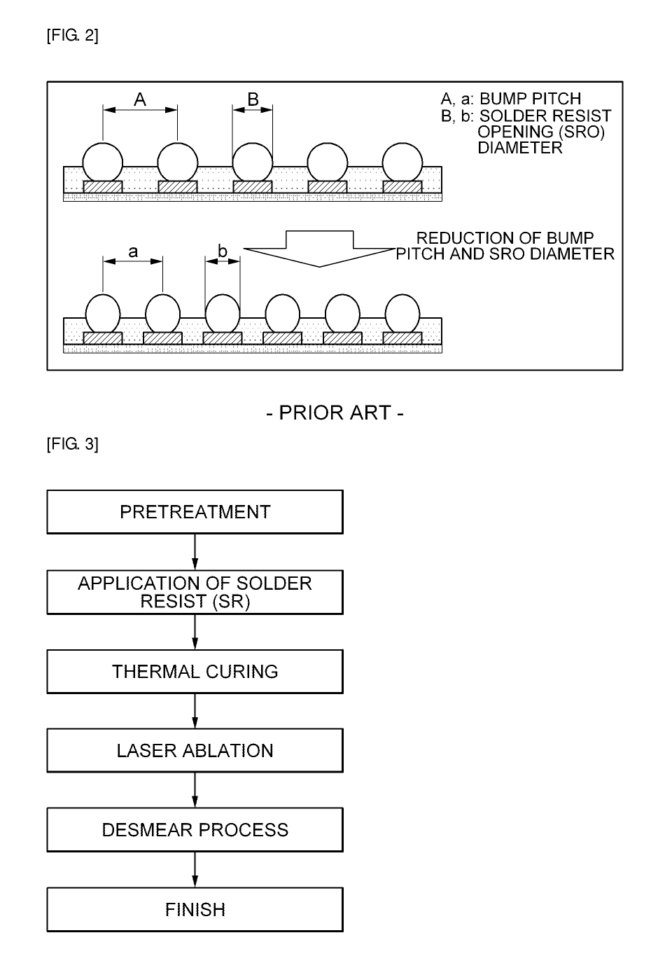

### DETAILED DESCRIPTION OF THE PREFERABLE EMBODIMENTS

Hereinafter, the present invention will be described in detail.

Terms used herein are provided to explain embodiments, not limiting the present invention. Throughout this specification, the singular form includes the plural form unless the context clearly indicates otherwise. Further, when terms “comprises” and/or “comprising” used herein specify existence of the above-mentioned shape, number, step, operation, member, element and/or groups thereof and do not preclude existence and addition of another shape, number, step, operation, member, element, and/or groups thereof.

The present invention relates to a thermosetting solder resist composition which can be applied to laser equipment or similar equipment with polymer resolution among methods of forming a solder resist opening of a board for a package, a board for a package (PKG) comprising a solder resist opening using the same, and a method for preparing the board for a PKG.

A thermosetting solder resist composition in accordance with the present invention is characterized in that it includes 1 to 10 parts by weight of a triazene curing agent represented as the following chemical formula 1, 1 to 10 parts by weight of a curing accelerator, and 10 to 50 parts by weight of a diluent, with respect to 100 parts by weight of an epoxy base.

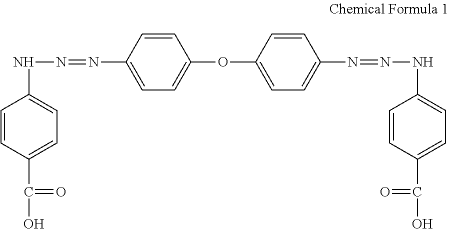 [SMILES: O=C(O)c1ccc(NN=Nc2ccc(Oc3ccc(N=NNc4ccc(C(=O)O)cc4)cc3)cc2)cc1]

The thermosetting solder resist composition in accordance with the present invention is characterized in that it specially uses the triazene compound represented as the chemical formula 1 as a curing agent.

The triazene compounds are a unique type of polyazo compounds including three consecutive nitrogen atoms in an acrylic arrangement. These compounds have been used as DNA alkylating agents in tumor therapy, iodo (I)-masking groups in synthesis of small or macromolecules, protecting groups for amines and diazonium salts, photoactive substrates, and precursors to various medical compounds.

When the triazene curing agent is exposed to laser ablation and the like, it is known that nitrogen chains of a triazene group (—N—N—N<) are emitted to cause a photochemical decomposition.

Therefore, the triazene curing agent has high laser processability, excellent processing shape, and excellent chemical stability compared to conventional other curing agents. Therefore, the present invention uses the triazene curing agent in the epoxy base, a thermosetting resin, to improve insulation and thermal stability.

The triazene curing agent may be included in an amount of 1 to 10 parts by weight, preferably, 1 to 4 parts by weight, with respect to 100 parts by weight of the epoxy base. When the triazene curing agent content is less than 1 part by weight with respect to 100 parts by weight of the epoxy base, curing effect is insufficient, and when exceeding 10 parts by weight, it is not preferred since the excessive curing agent exists in the cured product after a curing reaction and thus causes deterioration of thermal characteristics of the final solder resist, contact failure with a substrate, roughness or cracks of surface shape, and the like.

The triazene curing agent in accordance with the present invention may be synthesized through a first step of preparing a diazonium salt like the following reaction formula 1 and a second step of coupling the diazonium salt with 4-aminobenzoic acid. It is preferred that the triazene curing agent in accordance with the present invention is synthesized according to the following reaction formula 1.

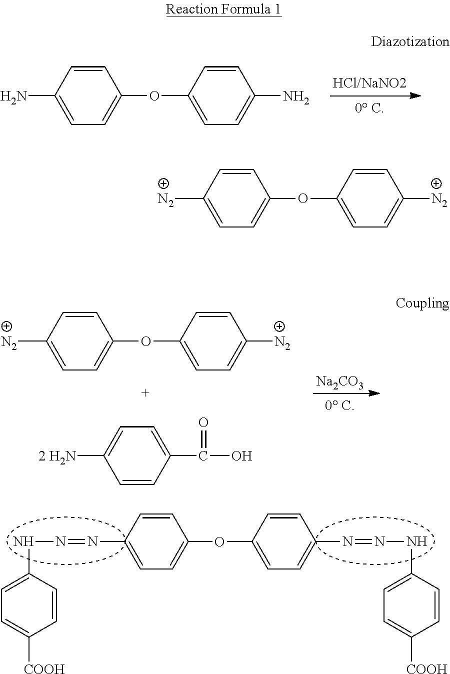

The epoxy base of the present invention may be selected from a bisphenol A-type epoxy resin represented as the following chemical formula 2, a bisphenol F-type epoxy resin represented as the following chemical formula 3, and an o-cresol novolac (OCN) epoxy resin represented as the following chemical formula 4.

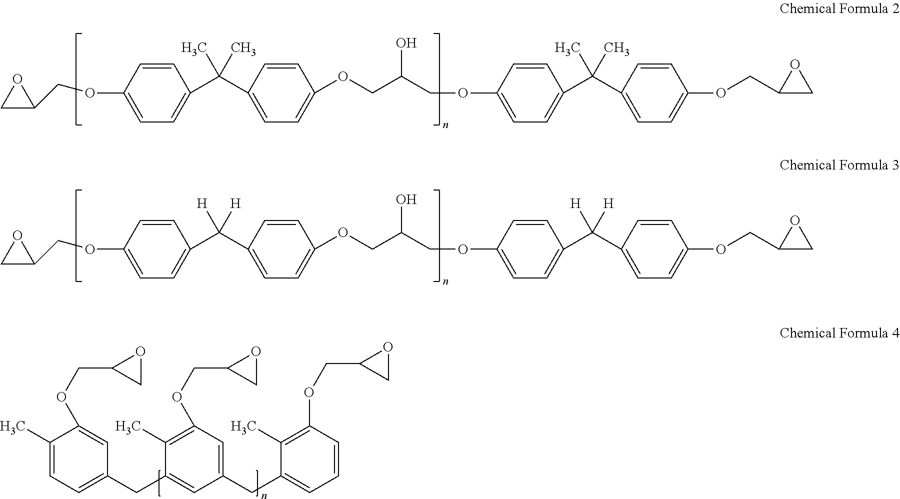

In the chemical formulas 2 to 4, n is 1 to 10.

Since the epoxy resin in accordance with the present invention exists in an oligomer state, it is preferred that n is maintained in the range of 1 to 10 to maintain appropriate viscosity for easy application after mixing.

The curing accelerator in accordance with the present invention may be at least one selected from the group consisting of amine derivatives, imidazole derivatives, and phosphine derivatives.

For a concrete example, the curing accelerator may be triphenylphosphine, triethylamine, 1,3-phenylenediamine, 2-methylimidazole, or 2-ethyl-4-methylimidazole (EMI) but not limited thereto. Among them, 2-ethyl-4-methylimidazole is the most preferred.

The curing accelerator may be included in an amount of 1 to 10 parts by weight, preferably 2 to 7 parts by weight, most preferably 3 to 4 parts by weight, with respect to 100 parts by weight of the epoxy resin.

In the present invention, it is possible to improve laser processability by using a mixture of the triazene coating agent and the curing accelerator to have low decomposition activation energy.

Further, the solder resist composition of the present invention uses the diluent for appropriate viscosity to facilitate application of the solder resist composition on the printed circuit board. The diluent is a ketone or ester diluent, specifically, at least one selected from the group consisting of diethylene glycol ethyl ether acetate, acetone, methyl ethyl ketone, N,N-dmethylmethanamide, and methyl cellosolve.

In the present invention, the diluent may be used in an amount of 10 to 50 parts by weight, preferably 40 to 45 parts by weight, with respect to 100 parts by weight of the epoxy resin.

Further, since the solder resist composition of the present invention includes the thermosetting resin, it is possible to achieve reduction in investment costs and increase in space utilization due to simplification of processes as well as to improve reliability of assembled products due to excellent thermal stability compared to a conventional photosensitive resist (PSR) material.

Meanwhile, the present invention may provide a board for a package (PKG) using the solder resist composition used for connection between a main board and semiconductors and a method for preparing the same.

The following FIG. 3 shows a schematic diagram of a process of forming a solder resist opening using laser among the processes of preparing a board for a PKG. Referring to this, first, the solder resist composition is applied on a pretreated board for a PKG.

The application of the solder resist (SR) may be performed by methods such as screen printing, roll coating, curtain coating, and spray coating, and the application method is not particularly limited.

The next step is a step of thermally curing the solder resist composition. It is preferred that the solder resist composition is thermally cured at a temperature of 150 to 190° C. for 40 to 90 minutes.

That is, the solder resist composition of the present invention includes only the thermosetting resin. Therefore, unlike a conventional solder resist composition which includes a photocurable resin and thus is cured by photoreaction, the size of an opening is not changed and there is no need for precise control of the speed and end time of photoreaction in order to reduce the size of the opening.

Further, after the thermal curing, in order to form a solder resist opening, laser processing is performed using similar equipment, which enables pyrolysis of polymers, as well as laser equipment such as CO₂ laser, YAG laser, and excimer laser equipment.

Next, a final board for a PKG may be prepared through a desmear process and so on.

In the board for a PKG in accordance with the present invention, a solder resist opening of less than 50 μm may be formed through laser ablation. Therefore, when using the solder resist composition of the present invention, it is possible to improve processability as well as to form a small-sized solder resist opening.

Hereinafter, preferred embodiments of the present invention will be described in detail. The following embodiments merely illustrate the present invention, and it should not be interpreted that the scope of the present invention is limited to the following embodiments. Further, although certain compounds are used in the following embodiments, it is apparent to those skilled in the art that equal or similar effects are shown even when using their equivalents.

### Embodiments 1 to 6

A solder resist composition is prepared by adding an o-cresol novolac epoxy resin, a triazene curing agent represented as the chemical formula 1, an imidazole derivative as a curing accelerator, and a diluent, with the composition as in the following table 1.

The solder resist composition is screen printed on a board and thermally cured at 170° C. for 60 minutes. Next, a solder resist opening is formed by performing laser ablation using CO₂ laser.

TABLE 1

| | Em- | Em- | Em- | Em- | Em- | Em- |
|---|---|---|---|---|---|---|
| | bodi- | bodi- | bodi- | bodi- | bodi- | bodi- |
| (Unit: g) | ment 1 | ment 2 | ment 3 | ment 4 | ment 5 | ment 6 |
| Epoxy base⁽¹⁾ | 4 | 4 | 4 | 4 | 4 | 4 |
| Curing | 0.04 | 0.08 | 0.12 | 0.04 | 0.08 | 0.12 |
| agent⁽²⁾ | | | | | | |
| Curing | 0.12 | 0.12 | 0.12 | 0.16 | 0.16 | 0.16 |
| accelerator⁽³⁾ | | | | | | |
| EMI/Curing | 3/1 | 3/2 | 3/3 | 4/1 | 4/2 | 4/3 |
| agent | | | | | | |
| (compared to | | | | | | |
| epoxy | | | | | | |
| content) | | | | | | |
| Diluent | 1.78 | 1.80 | 1.82 | 1.80 | 1.82 | 1.83 |
| (MEK + | | | | | | |
| DMF)⁽⁴⁾ | | | | | | |

⁽¹⁾o-cresol novolac epoxy resin represented as chemical formula 4
⁽²⁾curing agent: triazene compound represented as chemical formula 1
⁽³⁾curing accelerator: 2-ethyl-4-methylimidazole (EMI)
⁽⁴⁾MEK: methyl ethyl ketone, DMF: N,N-dmethylmethanamide, dilluent is added based on total solids (epoxy base, curing agent, curing accelerator).

### Comparative Examples 1 TO 3

In the compositions of the embodiments 1 to 6, solder resist compositions are prepared using a comparative example 1 in which a phenol curing agent represented as the following chemical formula 5 is used as a curing agent instead of a triazene compound, a comparative example 2 in which a tetrahydrophthalic anhydride (THPA) curing agent and EMI (3 parts by weight with respect to epoxy) as a curing accelerator are used, and a comparative example 3 in which a tetrahydrophthalic anhydride (THPA) curing agent and triethylamine (6 parts by weight with respect to epoxy) as a curing accelerator are used, and solder resist openings using the solder resist compositions are formed.

The other constituents are the same as those in the embodiments 1 to 6.

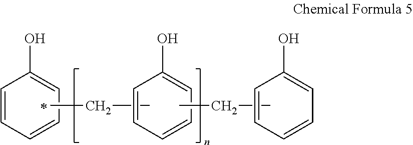

### Experimental Example 1

### Evaluation of Resolution

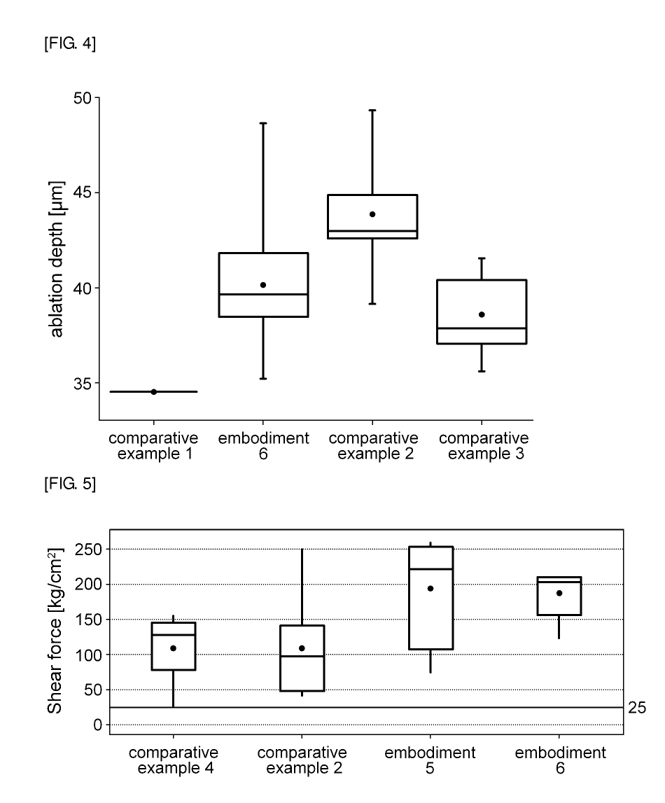

Differences in depth of the solder resist openings of the embodiment 6 and the comparative examples 1 to 3 and resolutions according to them are evaluated, and evaluation results are shown in the following table 2 and FIG. 4.

After calculating the differences in depth based on the depth of the opening formed from the solder resist composition using the phenol curing agent of the comparative example 1, resolutions increased from them are calculated as below.

Resolution increase=(opening depth difference/opening depth of comparative example 1)×100

TABLE 2

| | Opening | Opening depth | Resolution |
|---|---|---|---|
| | depth (μm) | difference (μm) | increase (%) |
| Comparative example 1 | 34.488 | — | — |
| Comparative example 2 | 43.877 | 9.389 | 27.230 |
| Comparative example 3 | 38.626 | 4.138 | 11.998 |
| Embodiment 6 | 40.22 | 5.732 | 16.620 |

As can be seen from the results in the table 2 and FIG. 4, as a result of processing the thermosetting solder resist compositions (comparative examples 1 to 3) using the phenol curing agent or the different kinds of curing agents and curing accelerators and the thermosetting solder resist composition (embodiment 6) using the triazene compound as a curing agent in the present invention under the same condition using CO₂ laser, it is shown that processability of the composition in accordance with the embodiment of the present invention is improved by average 17% compared to the conventional compositions.

### Experimental Example 2

### Evaluation of Adhesion with Board

Adhesion between a surface of solder resist, which are manufactured from the thermosetting solder resist compositions in accordance with the embodiments 5 and 6, the comparative example 2, and a comparative example 4 using the EMI content in an amount of 1 part by weight with respect to the epoxy in the comparative example 2, and epoxy mold compound (EMC) is measured by a shear test method, and measurement results are shown in the following table 3 and FIG. 5.

TABLE 3

| Unit: | Comparative | Comparative | | |
|---|---|---|---|---|
| Kgf/cm² | example 2 | example 4 | Embodiment 5 | Embodiment 6 |
| N | 10 | 6 | 4 | 5 |
| Average | 110.2 | 107.5 | 194.8 | 187.7 |
| Error | 14.2 | 31.0 | 42.2 | 16.8 |
| Deviation | 44.8 | 76.0 | 84.4 | 37.6 |
| Minimum | 18.4 | 40.5 | 72.0 | 121.6 |
| Q1 | 77.1 | 46.7 | 106.6 | 157.3 |
| Median | 127.6 | 98.4 | 223.0 | 204.4 |
| Q3 | 144.6 | 143.6 | 254.7 | 209.6 |
| Maximum | 156.5 | 251.6 | 261.2 | 211.0 |

(annotations)
N: number of measured samples (sample size)
Q1: numerical value at which the range of data corresponds to the lowest 25% in statistical analysis results
Median: numerical value at which the range of data corresponds to the lowest 50% in statistical analysis results
Q3: numerical value at which the range of data corresponds to the lowest 75% in statistical analysis results

As in the results of the table 3 and FIG. 5, it is measured that the adhesion between the EMC and the surface of solder resist in the embodiments 5 and 6 is high by more than 80% compared to the comparative examples 2 and 4. Therefore, it is possible to improve reliability for adhesion failure in customers' evaluation of reliability of a packaging process.

Further, it is checked that the adhesion of the composition of the present invention is greater than 72 kgf/cm², which exceeds 25 kgf/cm², a typically required PCB reliability standard, and from this result, it is checked that the composition of the present invention has a higher level of reliability than is required by customers.

According to the present invention, it is possible to form a small solder resist opening of less than about 50 μm through laser ablation by using a thermosetting solder resist composition including a triazene curing agent and to improve laser processability of the thermosetting solder resist composition compared to existing thermosetting solder resist. Further, it is possible to improve reliability of an assembled board for a PKG by securing adhesion between an epoxy resin and solder resist.

Further, according to the present invention, it is possible to extend life of laser equipment by improving laser processing speed and reducing laser power.

Further, since it is possible to prevent damage to a copper circuit layer, a substrate under solder resist through downward adjustment of laser power, it is possible to implement a small copper thickness according to a fine circuit. Further, it is possible to secure long-term reliability by improving assembly reliability.

What is claimed is:

1. A solder resist composition comprising:
1 to 10 parts by weight of a triazene curing agent represented as the following chemical formula 1, 1 to 10 parts by weight of a curing accelerator, and 10 to 50 parts by weight of a diluent, with respect to 100 parts by weight of an epoxy base.

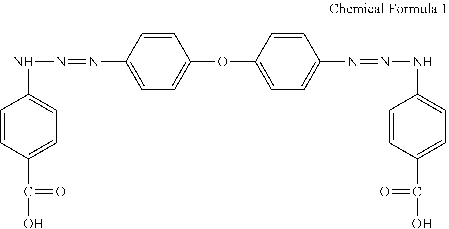 [SMILES: O=C(O)c1ccc(NN=Nc2ccc(Oc3ccc(N=NNc4ccc(C(=O)O)cc4)cc3)cc2)cc1]

2. The solder resist composition according to claim 1, wherein the epoxy base is at least one selected from compounds represented as the following chemical formulas 2 to 4, and in the chemical formulas 2 to 4, n is 1 to 10.

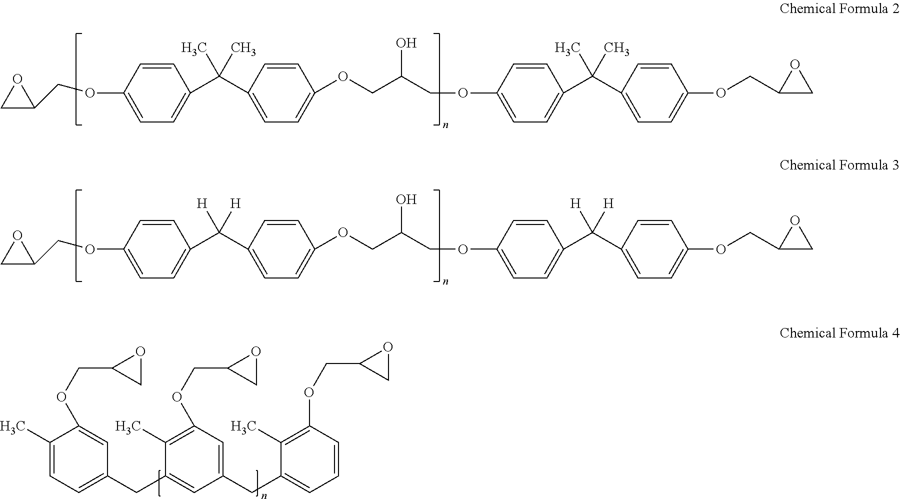

3. The solder resist composition according to claim 1, wherein the curing accelerator is at least one selected from the group consisting of amine derivatives, imidazole derivatives, and phosphine derivatives.

4. The solder resist composition according to claim 3, wherein the curing accelerator is triphenylphosphine, triethylamine, 1,3-phenylenediamine, 2-methylimidazole, and 2-ethyl-4-methylimidazole.

5. The solder resist composition according to claim 1, wherein the composition is a thermosetting solder resist composition.

6. A board for a package comprising a solder resist opening using the solder resist composition according to claim 1.

7. A method for preparing a board for a package comprising:
applying a solder resist composition on a board;
curing the solder resist composition; and
forming an opening in the cured solder resist.

8. The method for preparing a board for a package according to claim 7, wherein the solder resist composition comprises 1 to 10 parts by weight of a triazene curing agent represented as the chemical formula 1, 1 to 10 parts by weight of a curing accelerator, and 10 to 50 parts by weight of a diluent, with respect to 100 parts by weight of an epoxy base.

9. The method for preparing a board for a package according to claim 7, wherein the formation of the solder resist opening uses laser ablation.

10. The method for preparing a board for a package according to claim 9, wherein the laser ablation uses CO₂ laser, YAG laser, and excimer laser equipment and equipment which enables pyrolysis of polymers.
